(19) United States
(12) Patent Application Publication
(10) Pub. No.: US 2012/0040546 A1
(43) Pub. Date: Feb. 16, 2012

(54) Very High Frequency Electrical Connector

(75) Inventors: Gert Droesbeke, Geel (BE); Stéphane Barlerin, Fatines (FR); Antoine Fares-Karam, Besancon (FR); David Lemarechal, Melay (FR); Yves Stricot, Villepreux (FR)

(73) Assignee: FCI, Versailles (FR)

(21) Appl. No.: 11/630,216

(22) PCT Filed: Jun. 30, 2005
(86) PCT No.: PCT/EP2005/007059

§ 371 Date: Dec. 13, 2007

(30) Foreign Application Priority Data
Jun. 30, 2004 (FR) 04 51373

(51) Int. Cl. H01R 13/52

(52) U.S. Cl. 439/271

(57) ABSTRACT

The invention concerns an electrical connector including a box, at least one electrically conductive track and a plurality of first electrical contacts, the first contacts being designed to come into contact with complementary second electrical contacts of a complementary connection device. In order to reduce the manufacturing cost of such an electrical connector and increase the electronic data transfer capacity through this electrical connector, the invention provides that the first electrical contacts are connected to electrically conductive tracks by joining, and that the box is formed by at least one molded plastic that is at least partially metal-coated to form the electrically conductive tracks.

The invention concerns an electrical connector for electric cables operating at very high frequencies, for example from 30 to 300 GigaHertz (GHz). The invention can be applied to the connector technology field, and can also be applied in other fields.

Such an electrical connector, which permits connecting a complementary connection device to an electrical cable, usually has an insulating frame forming a box, a board coated with a printed circuit (or PCB board), and first electrical contacts. The printed circuit has electrically conductive tracks, a first end of which is connected to a corresponding first electrical contact and the other end is connected to a corresponding electrical wire.

In order to compensate for the electrical impedance of the cable, which impedance is, among other things, a function of the cable length, the addition of passive electronic components (resistor, capacitor, etc.) to the PCB board is known. However, depending on the length of the cable and due to the very high frequencies, it may be necessary to add a large number of these components. The increase in the number of these components can lead to excess space requirements of the box that can disrupt the connections between each of the first contacts and each of the corresponding printed tracks, among other things. Therefore, it may become difficult to obtain an optimal electronic data transmission for electrical connectors of very high frequencies.

One object of the invention is to propose a connector for electrical cables whose manufacturing cost is reduced, whose dimensions are compact and that can also assure an optimal high-frequency electronic data transmission.

For this purpose, an electrical connector according to claim 1 is provided.

In fact, the electrical connector is obtained at least by means of molding a plastic in order to form a box, which is then partially metal-coated to form the conductive tracks. The box thus molded, forms a single support unit holding the board and the frame.

Creating such an electrical connector does not require assembling a printed circuit board onto a frame, which permits reducing not only manufacturing costs, but also the dimensions of the box without harming the electronic data transmission.

The box is made in such a way that it has at least one cavity to receive the first electrical contacts capable of receiving the second electrical contacts of a complementary connection device, at a site near the front face of the connector.

According to a variant, the first electrical contacts are inserted in the molded box. In an advantageous manner, these first contacts are formed from a metal plate and have an extension designed to be connected to a conductive track, for example, by soldering.

According to another variant, the first electrical contacts can be made by molding a plastic in order to form at least one elastic “blade”. This blade can be made an integral part of the box or can even be glued or embedded in the box. This blade is partially metal-coated so as to electrically connect a second electrical contact to the corresponding track.

The box can also comprise at least one means of positioning the electrical wire in order to assure its alignment relative to the plane formed by the bottom of the box. These positioning means can be a groove or an anvil-shaped piece. This groove and this anvil piece are made in such a way that they have a shape that is partially adapted to that of the electrical wire. Thus this groove and this anvil piece advantageously permit receiving at least one electrical wire while assuring a stable hold of this wire in the box. In an advantageous manner, the surface designed to be in contact with the electrical wire can be at least partially covered with an abrasion product so as to reinforce the holding of the wire in the box.

The box can comprise at least one longitudinal channel positioned between at least two electrical wires. This channel is advantageously metal-coated so as to form an electromagnetic screen relative to these two electrical wires.

Other variants and embodiments corresponding to the characteristics according to claims 2 to 11 are described hereunder.

The invention will be better understood upon reading the description that follows and examining figures that accompany it. These latter are only given by way of indication and do not at all limit the invention. The figures show:

FIG. 1: A perspective view of an electrical connector, according to the invention;

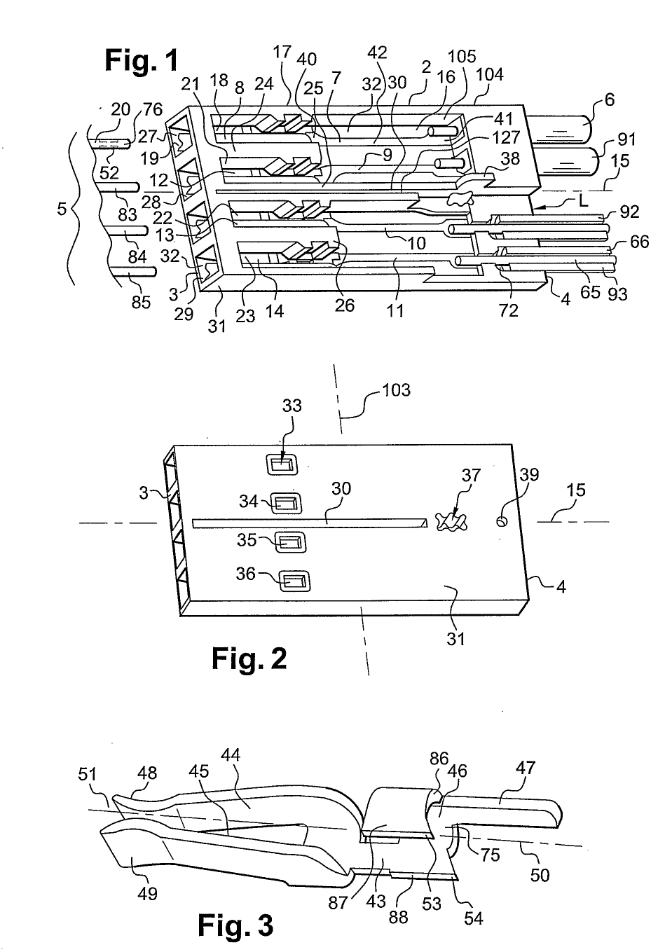

FIG. 2: A view of an electrical connector viewed from the bottom, according to the invention;

FIG. 3: A three-dimensional view of a first electrical contact, according to the invention;

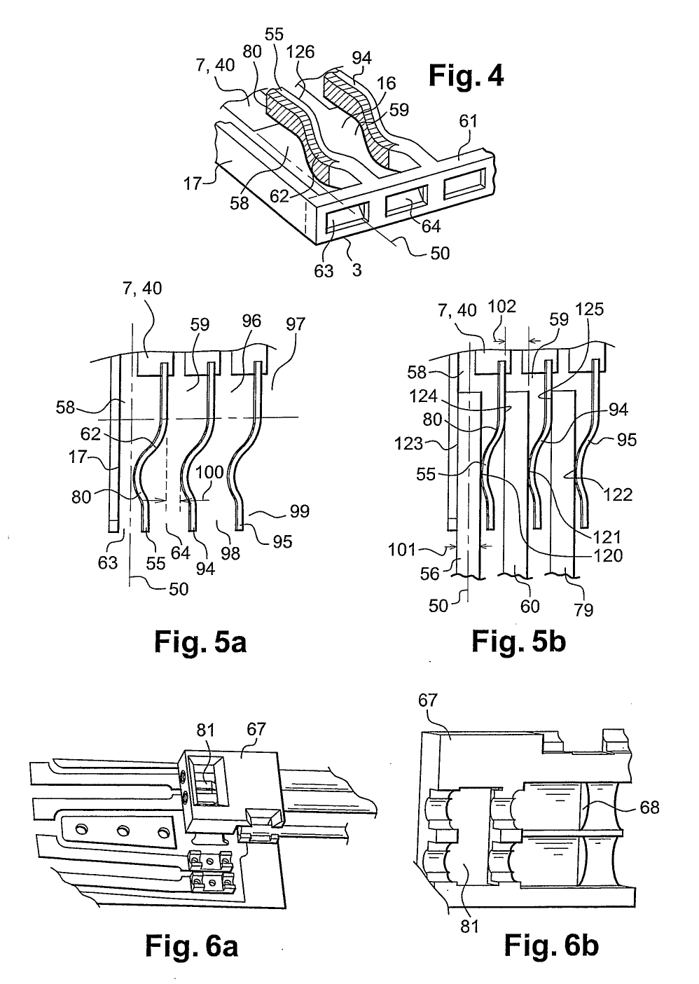

FIG. 4: A schematic diagram of a first electrical contact, according to a variant of the invention;

FIGS. 5a and 5b: schematic sectional diagrams of a first electrical contact, according to a variant of the invention;

FIGS. 6a and 6b: Schematic diagrams of a protection cover, according to the invention;

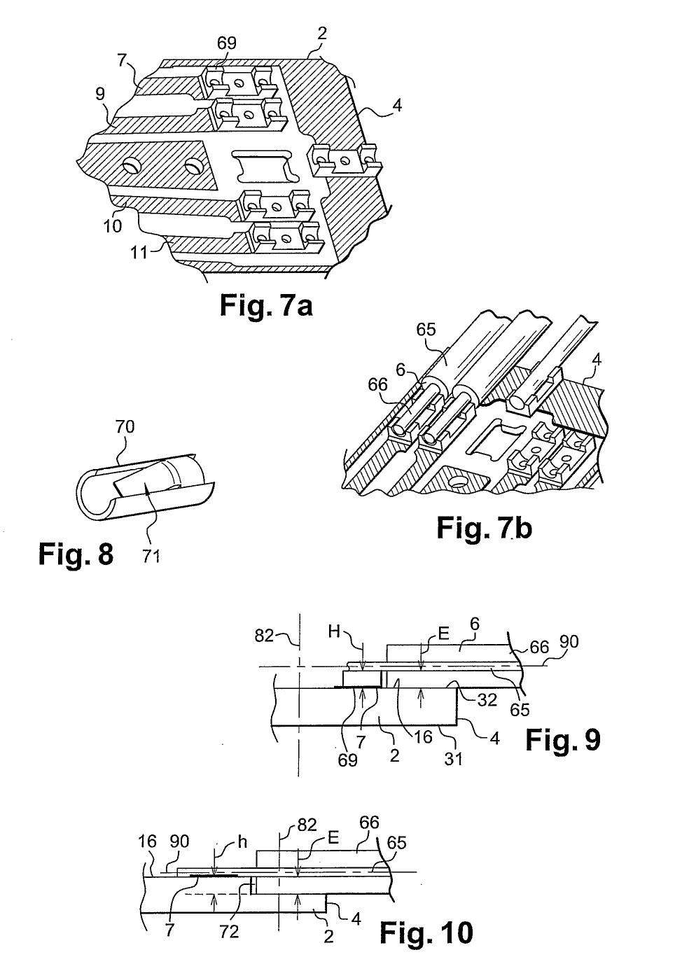

FIGS. 7a and 7b: Views of at least one anvil-shaped piece for receiving an electrical wire, according to the invention;

FIG. 8: A schematic diagram of a grapple piece according to the invention,

FIG. 9: A schematic diagram of a cross section of a connector at a site near the rear face of the connector, according to the invention;

FIG. 10: A schematic diagram of a cross section of a connector at an area near the rear face of the connector, according to a variant of the invention;

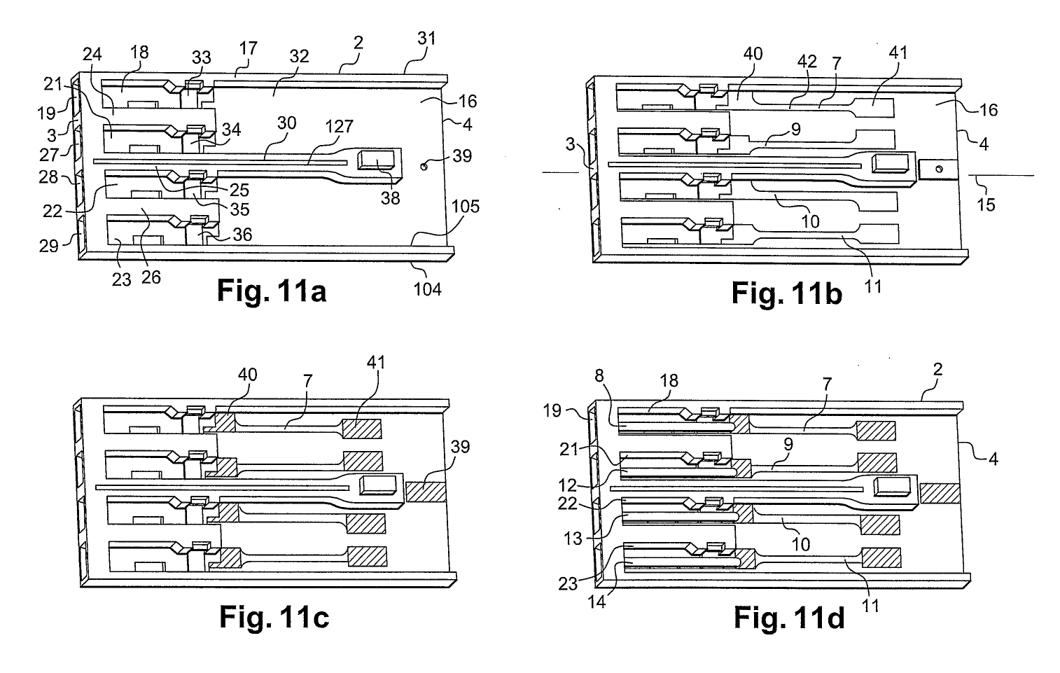

FIGS. 11a to 11d: Perspective views of a manufacturing process for an electrical connector, according to the invention;

FIG. 1 illustrates an electrical connector 1, according to the invention; Electrical connector 1 has an insulating box 2, electrically conductive tracks 7, 9, 10 and 11 connected to a plurality of deformable first electrical contacts 8, 12, 13, 14, arranged parallel relative to one another along a lengthwise or elongation axis 15 of the connector. Each of the first electrical contacts is designed to be connected to a corresponding second electrical contact 20, 83, 84, 85. These second contacts are formed by a complementary connection device 5.

The connector has a front face 3 and a rear face 4. Front face 3 of the connector, for example, is a face by means of which the second electrical contacts of complementary connection 5 are inserted into connector 1. Rear face 4 of the connector is a face by means of which electrically conductive wires 6, formed by an electrical cable (not shown), are inserted into this same connector 1. In the example of FIG. 1, the cable has four electric wires such as 6, 91, 92, and 93. Each of these wires is formed by a strand 65 and a protective sheath 66. The protective sheath surrounds the strand. The electrical wire assembly can be surrounded by a woven metal piece (not shown) to form the electrical cable. Each of these wires is designed to be connected to a corresponding conductive track.

According to the invention, the first electrical contacts are connected to corresponding conductive tracks by joining. Here, “joining” is meant to be a superimposition of the first contact with a corresponding zone of the conductive track to form an electrical connection between the first contact and the track.

According to the invention, such a connector 1 is made by means of molding a plastic material in order to form box 2, which box is partially metal-coated to form electrically-conductive tracks 7, 9, 10 and 11. Molding can be done by an MID (Molded Interconnection Device) technique. This MID technique involves at least one plastic molding in order to form case 2.

Molded box 2 has a bottom 16 and a wall 17 at least partially peripheral. This wall 17 extends perpendicularly to a plane formed by bottom 16. The tracks, for example of copper, are formed on the inner surface 32 of bottom 16 of box 2.

Each of the tracks extends longitudinally along elongation axis 15 of the connector from front face 3 in the direction of rear face 4 of the connector. Each of the tracks has a first termination 40 near the front face 3 and a second termination 41 near the rear face 4. The first termination and the second termination are connected to one another by an elongated section 42. Each of these terminations 40 and 41 has a flared shape relative to the elongated central section 42. This flared shape advantageously permits increasing the contact surface, which facilitates the positioning of the first electrical contacts and the electrical wires on the conductive tracks.

The box forms at least one cavity 18 to receive at least one electrical contact 8 at a site near front face 3. This cavity facilitates the insertion of the first contact into the box and permits assuring a stable positioning of the first contact in the box. In the embodiment described in FIG. 1, box 2 has a first cavity 18, a second cavity 21, a third cavity 22 and a fourth cavity 23. Each of these cavities 18, 21, 22 and 23 receives first contacts 8, 12, 13 and 14, respectively.

First cavity 18 is separated from second cavity 21 by a first partition 24. Second cavity 21 is separated from third cavity 22 by a second partition 25. Third cavity 22 is separated from fourth cavity 23 by a third partition 26.

Partitions 24, 25, and 26 according to FIG. 1 are made in such a way that they extend perpendicularly relative to the plane formed by bottom 16 of box 2 and partially along the box, from front face 3 in the direction of rear face 4. These partitions 24, 25 and 26 can, of course, extend over the entire length L of the box. Such partitions extending along the entire length can advantageously serve as an insertion guide to facilitate the insertion of the electrical wires into the box.

Each of the cavities 18, 21, 22 and 23, respectively, has an opening 19, 27, 28 and 29 formed through wall 17 of front face 3 of the connector. These openings 19, 27, 28 and 29 each allow the passage of a corresponding second electrical contact.

FIG. 2 is a bottom view of the connector in which box 2 has a central channel 30 extending parallelly to elongation axis 15 of the connector. Channel 30 is the result of a deformation of the outer surface of the box in the direction of the inner surface, so that the inner surface projects relative to the plane of bottom 16 of the box. Channel 30 can be communicating, i.e., it communicates by a slot 127 from outer surface 31 towards inner surface 32 of the box. Channel 30 can form a partition as is shown in FIG. 1.

Outer surface 31 of the box can be at least partially metal-coated so that at least one part of a surface defined by the channel is metal-coated. Such a metal-coated channel thus advantageously permits forming an electromagnetic screen relative to at least two tracks placed on either side of this channel 30.

Bottom 16 of box 2 also has a plurality of communicating holes 33, 34, 35, 36, such as shown in FIG. 2. These communicating holes are distributed two by two on either side of channel 30 along an axis 103 perpendicular to elongation axis 15 of the box. These holes are designed to be at least partially covered by a corresponding first electrical contact. The holes facilitate the positioning of the first contacts in the case.

The box comprises attachment means 37, 38 (FIGS. 1 and 2). These attachment means 37, 38 permit stacking several connectors according to the invention, one below the other. These attachment means can form a depression 37 visible on outer surface 31 of the box and which forms a protuberance 38 visible on inner surface 32 of the box. Thus during the stacking of a first connector on top of a second connector, protuberance 38 of the second connector is engaged in depression 37 of the first connector.

Finally, the box is pierced by a central recess 39 (FIG. 2). This central recess 39 is situated at a place close to the rear face 4 of the connector. This recess is communicating and also extends from outer surface 31 to inner surface 32.

Channel 30, depression 37 as well as recess 39 can be aligned with one another along elongation axis 15 of the connector.

FIG. 3 shows one example of embodiment of a first electrical contact 8 according to the invention. First electrical contact 8 of connector 1 can be made from sheet metal by stamping. This sheet metal is cut out to form a clamp comprising a central piece 43 of rectangular shape, a first arm 44, a second arm 45, a hook piece 46 and an extension 47.

The two arms 44 and 45 are positioned perpendicularly relative to a plane formed by central piece 43 and are parallel to one another. The two arms 44 and 45 each have an end 48 and 49 converging toward one another without touching. Or, the two arms 44 and 45 may even touch at their ends. More precisely, the two arms 44 and 45 form a clamp designed to receive a second electrical contact. Each of these ends 48 and 49 forms a surface curved in such a way that these rounded curved surfaces are placed facing one another.

At the place where ends 48 and 49 join, the two arms define an opening 51 into which the second electrical contact is inserted. During insertion of the second contact into opening 51, a reversible elastic radial spreading apart of each of arms 44 and 45 is produced relative to the insertion axis at the same time that the second contact comes to be supported against the curved surface of ends 48 and 49.

The hook piece 46 extends from central piece 43 perpendicularly to an axis 50 and in the plane formed by central piece 43. This hook piece 46 is folded over central piece 43 to form a partially-closed orifice 75. This hook piece 46 permits elastically receiving an end 52 of second contact 20 while being adapted to the shape of this same end 52. For example, end 52 of second contact 20 can comprise a constricted circular cylindrical part that is inserted into hook piece 46 by allowing end 76 of second contact 20 to pass. End 76 permits holding the second contact in the box since it can be supported against edges 86 of the hook piece.

Extension 47 extends longitudinally from this hook piece 46 relative to axis 50, from front face 3 in the direction of rear face 4 of connector 1. The first electrical contact is also made in such a way that one of the two arms is situated in the same plane as that formed by extension 47.

The first electrical contact is positioned in the plane formed by extension 47 parallel to the plane formed by bottom 16 of the box. Extension 47 is positioned on first termination 40 of the track while at least a part of hook piece 46 at least partially covers a corresponding communicating hole of the box. Alternatively, a part of hook piece 46 is inserted partially into the corresponding communicating hole to attach the first contact to the box. The first electrical contact is also positioned with a plane formed by one of the two arms situated in the same plane as the one where extension 47 is formed, supported against the bottom of the box. Extension 47 is positioned on the second termination of the track by joining while being soldered to the track.

The hole such as 33, 34, 35 and 36 previously described facilitates the positioning of the first electrical contact by crimping a sheet metal formed by the first contact in this hole.

By way of example, hook piece 46 forms an open tube with a first end 87 and a second end 88 situated facing one another. Each of ends 87 and 88 forms, at a site far from front face 3, a first and second clutching piece 53, 54. The first contact can also be held by while coming to be partially inserted in hole 33 made in the box, while being slightly bent in this same hole.

In a variant of the invention (FIG. 4) at least one plastic elastic blade 55 is molded and then partially metal-coated to form a first electrical contact. The blade according to the variant can be made by the MID technique as previously mentioned.

Blade 55 comprises a base 61 and an elongated body 126. The blade can be inserted in a fixed manner into the box by embedding the base in wall 17 of the box.

Alternatively, the box can also be molded so as to form the blade connected to a single support at wall 17.

Blade 55 is partially coated with a metal strip 80 that has the function of electrically connecting a second contact to the corresponding track (FIG. 5b). This metal strip 80 is shown by the shading of FIG. 4.

FIGS. 5a and 5b are plan views of an electrical connector according to the invention before and after insertion of second contacts. In this example, the connector comprises a first elastic blade 55, a second elastic blade 94 and a third elastic blade 95. Each of these blades is designed to electrically connect a corresponding second contact 56, 60, 79. The three blades define four compartments 58, 59, 96 and 97. Each of the compartments respectively communicates by an opening 63, 64, 98, 99 that permits the passage of the corresponding second contact into the box. The opening is made passing through edge 61. When a second contact is inserted into the box through the opening, it is found held between two adjacent blades. Second contact 60 is supported against metal-coated part 121 of a first blade on one side, and against the non-metal-coated part 124 of a second adjacent blade on the other side. It should be noted that for the second contact 56 situated at the end, the non-metal-coated part is made up by wall 17 of box 2.

Such an embodiment of the metal-coated blade advantageously permits preventing the second contacts from short-circuiting each other.

Each blade has a bent surface 62 tending to partially obstruct a portion of compartment 58, 59, 96, on the inside of which the second contact 56, 60, 79 is inserted.

The blade can advantageously be metal-coated at the level of curve 62. By being in contact with curve 62, the second contact is supported elastically against the blade, which assures a continuous and reliable contact of the second contact.

The insertion of the second contacts into constricted compartment 58, 59, 96 beyond curve 62 leads to a radial separation of the blade relative to insertion axis 50 of the second contact. This radial separation is obtained by sliding the blade along bottom 16 of the box in order to allow the passage of the second contact into the compartment.

It can notably be provided that when the blade is separated relative to the axis of insertion of the second contact, the blade is at least temporarily in contact with printed track 7, 40. In particular, it can be provided that the blade is in contact with the printed track by its metal strip 80 when it is or is not in contact with the second contact.

Each of the blades is ribbed in such a way that at an area of the compartment where curve 62 is situated, a width 100 of the compartment defined between two blades positioned next to one another is less than the thickness 101 of the second contact (FIGS. 5a and 5b). Each of the blades is made in such a way that during the insertion of the second contact into the box, the blade is separated elastically and radially relative to insertion axis 50 and defines another width 102 corresponding to the thickness 101 of the second contact so as to assure that the contact is held in the box.

The electrical wires designed to be inserted into the connector are each formed by an electric strand 65 and a protection sheath 66, the sheath surrounding the strand (FIG. 1). Electric wire 6 is inserted into box 2 through rear face 4 by means of stripped strand 65 which is placed in contact with the corresponding electrically conductive track. In an example, FIG. 1, a first electric wire 6, a second electric wire 91, a third electric wire 92 and a fourth electric wire 93 are placed in direct contact with first track 7, second track 9, third track 10 and fourth track 11. Each of the stripped strands is soldered to second termination 41 of the corresponding track. The woven metal piece of the cable can be grounded at a metal-coated area near recess 39.

The electrical wire is inserted into the box by rear face 4 parallel to bottom 16 of case 2. In order to do this, the box comprises at least one metal anvil piece 69 (FIGS. 7a and 7b) positioned in contact with a corresponding track. The anvil piece has a shape partially adapted to this stripped strand of the electric wire. For this purpose, the anvil piece has a height H corresponding to the thickness E of sheath 66. Height H and thickness E are measured along an axis 82 perpendicular to the plane of bottom 16.

In another variant of the invention, the box comprises at least one groove 72 at an area of the box near rear face 4 (FIG. 10). In order to form this groove, the box has a hole of a height h corresponding to thickness E of sheath 66 (FIGS. 1 and 10) measured along axis 82 and which extends along elongation axis 15. The stripped strand is then placed in contact with the track coming out from the groove parallel to the plane of bottom 16.

In another variant of the invention, the connector can comprise at least one grapple piece 70 (FIG. 8). Grapple piece 70 is formed by an open metal tube having a sharp valve piece 71. Grapple piece 70 can be soldered to the second termination of the track. The grapple piece permits receiving the electrical wire which is positioned longitudinally relative to axis 15 inside the open tube while being gripped by valve piece 71. This valve piece is designed to cut through the protective sheath of the wire in order to come into contact with the strand. The strand is then connected to the track by means of the grapple piece.

In order to assure that the electrical wire is held in box 2, this box can be partially covered by an insulating cover 67 in an area of the box where electrical wire 6 penetrates (FIGS. 6a and 6b). FIG. 6a shows a cover 67 viewed from the top, and FIG. 6b shows a cover 67 viewed from the bottom This cover 67 is also molded in such a way that it is adapted to the shape of electrical wire 6, with a first section mated to the shape of stripped strand 65 and a second section adapted to that of strand 65 with its sheath 66.

This cover 67 is molded so as to also form at least one setback portion 68 that is gripped on sheath 66 of electrical wire 6. This setback portion 68 permits holding the electrical wire in the case. This cover also has an opening 81 that allows a part of the stripped strand of the electrical wire to appear. Cover 67 can also have a shape adapted to that of anvil piece 69 (FIG. 6b).

According to another variant of the invention, electrical connector 1 can be made by several moldings. In FIGS. 7a to 7b, an insulating box 2 is shown, which is formed by a first molding of plastic, and by a second molding of a metal-coated plastic. This second plastic molding is designed to be partially metal-coated to form the future electrically conductive tracks. The first plastic molding permits electrically separating the tracks from one another. The second molding is shown by shading in FIGS. 7a and 7b.

The outer surface of the box is advantageously partially metal-coated to form an electromagnetic screen.

The metallization of the outer surface also comprises a metallization of the outer edges of peripheral wall 17. In fact, the peripheral wall forms an outer edge 104 and an inner edge 105, the inner edge being a part of the inner surface of the box and the outer edge forming a part of the outer surface of the same box.

The manufacturing process for such an electrical connector is described in regard to FIGS. 11a to 11d. First of all, at least one plastic molding is made in order to form the box as previously described (FIG. 11a). Then this box is metal-coated to form at least one electrically conductive track (FIG. 11b). A part of inner surface 32 of the box situated in the vicinity of recess 39 can also be metal-coated.

Then each of the tracks obtained can be partially coated with a layer of tin by tin-plating of first termination 40 and of second termination 41 (FIG. 11c). This layer of tin, shown by the shading of FIG. 11c permits soldering the first electrical contacts to the corresponding track, on the one hand, and soldering electrical wire 6 to the track, on the other hand. Recess 39 and the zone having a metal-coated surface in the vicinity of recess 39 can also be coated with a layer of tin.

Then outer surface 31 of the box is metal-coated. Then the first electrical contacts are inserted into the box (FIG. 11d).

It is then sufficient to insert the electrical wires through rear face 4 of the connector, in order to position them in contact with the corresponding conductive track. The electrical wires can then be placed in an anvil piece, or even in a groove as previously described. A surface of the anvil piece or the groove designed to be in contact with the wire can be coated with an abrasion product which has the purpose of increasing the hold of the wire in the box once heated. The electrical cable can be connected to a metal-coated site near recess 39 in order to ground the cable.

Then the second contact is inserted into the corresponding cavity to connect it to a corresponding first electrical contact.

1. A connector for an electrical cable comprising:
a box formed by at least one molded plastic having a bottom;
a plurality of first electrical contacts designed to come into contact with complementary second electrical contacts of a complementary connection device, these first contacts being connected to electrically conductive tracks by joining, characterized in that the conductive tracks are made on the bottom of the box and are directly connected electrically to strands of electrical wire.

2. The connector according to claim 1, further characterized in that each of contacts forms a metal clamp placed in a cavity of box facing a contact zone with track.

3. The connector according to claim 1, further characterized in that each of first contacts has an extension soldered onto the track.

4. The connector according to claim 1, further characterized in that each of the first contacts comprises a first arm and a second arm, connected to each other by a central plate, the first arm and the second arm tending to move apart elastically and reversibly from one another when a complementary second electrical contact is inserted between these two arms.

5. The connector according to claim 1, further characterized in that each of the first electrical contacts forms a flexible plastic blade partially metal-coated with a metal strip, the metal strip being placed facing a contact zone with the track in order to electrically connect a second contact to the corresponding conductive track.

6. The connector according to claim 5, further characterized in that the blade has at least one curve on which a second contact is supported during its insertion, said curve tending to be radially separated from the insertion axis of the second contact.

7. The connector according to claim 1, further characterized in that the box has an outer surface and an inner surface, the inner surface being covered with the electrically conductive track and the outer surface being at least partially metal-coated to form an electromagnetic screen.

8. The connector according to claim 1, further characterized in that on the side opposite the second contacts, the electrical connector receives electrical wires which are connected to a corresponding conductive track in such a way that each part of the wire inserted into the box forms a rectilinear line parallel to a plane formed by bottom of the box.

9. The connector according to claim 8, further characterized in that it comprises at least one metal anvil piece, positioned on a zone of a corresponding track, said anvil piece being able to receive a stripped strand of an electrical wire and having a height H corresponding to the thickness E of a protective sheath of the electrical wire.

10. The connector according to claim 8, further characterized in that it has at least one groove being able to receive at least one corresponding electrical wire, which groove has a shape at least partially adapted to the shape of the electrical wire, said groove being made from bottom of the box of a height h corresponding to thickness E of a protective sheath of the electrical wire.

11. The connector according to claim 1, further characterized in that it comprises at least one metal grapple piece soldered to a conductive track, said grapple piece having a sharp valve piece that can cut the protective sheath of the electrical wire in order to come into contact with the electrical strand.
